(19) United States
(12) Patent Application Publication
(10) Pub. No.: US 2005/0080778 A1
(43) Pub. Date: Apr. 14, 2005

(54) System and method using universal substitute values in database tables

(76) Inventors: Yvan Pochon, Geneva (CH); Thierry LeMaire, Geneva (CH); Viet Dang, Geneva (CH); Angelo Rageth, Geneva (CH); Alberto De Min, Geneva (CH); Michael O'Sullivan, Didcot (GB)

Correspondence Address: MOETTELI & ASSOCIES SARL, CASE POSTALE 486, AVE DE FRONTENEX 6, GEVEVA 12, CH-1211, CH

(21) Appl. No.: 10/963,164

(22) Filed: Oct. 12, 2004

Related U.S. Application Data
(60) Provisional application No. 60/510,981, filed on Oct. 14, 2003.

(51) Int. Cl. G06F 7/00

(52) U.S. Cl. 707/3; 707/1

(57) ABSTRACT

A computerized method of populating a database composed of rows with applicability fields and parameter fields in a data structure, and of retrieving the data, such that the database may be used to yield relevant results with a minimum of data entries. In a first step, the method defines a hierarchy of applicability fields to suit a particular business model as well as the associated univocal retrieval process. In a second step, the method substitutes unknown applicability fields with a USUB. In a third step, the method prompts the input of appropriate parameter field values for the rows of applicability fields, including those having one or more USUBs. A retrieval method retrieves the data in the data structure. The invention thus enables the population and data retrieval from a database structure such that the database is useful to yield relevant results with a minimum of data entries.

### BACKGROUND OF THE INVENTION

This invention relates to database management systems and methods, more particularly methods and systems of populating databases with data such that relevant results can be accessed with a minimum of inputs.

The airline industry, in particular, must consider many variables when calculating cost of operation or other performance indicators. This requires tedious entry of data for each possible combination of sometimes unknown service and cost components, prior to the database being of use (i.e., a relevant non “null” value is retrieved).

U.S. Pat. No. 6,556,958 to Chickering, the content of which is incorporated herein by reference thereto, describes an internal database population and data retrieving method dealing with sparcely populated data. This patent describes a structural approach to simplifying database population in which value selection where actual values are unknown or not yet input is invisible to the end user. The method represents a complicated work around to completing values in a database, such work around involving detailed analysis of the input data, in order to determine what values can be substituted for empty fields, so as to make the database useful to the end user where many fields are not yet populated.

What is needed is a method of populating a database such that a simple database may be used to yield relevant results rapidly with a minimum of data entries. What is needed is a method of populating a database in which the user has greater control of the nature of the value which substitutes for a substitute of an element of a set of possible values. What is needed is a method of univocally retrieving the relevant data stored according to this population method.

### SUMMARY OF THE INVENTION

A computerized method is encoded on a computer-readable medium for operation on a computer system. The method populates a database table composed of rows with applicability fields and parameter fields, such that the database may be used to yield relevant results with a minimum of data entries. The method includes the steps of:
a) defining a hierarchy of applicability fields to suit a particular business model, along with the univocal retrieval process;
b) substituting unknown applicability fields with a universal substitute value (“USUB”); and
c) inputting appropriate parameter field values for the rows of applicability fields, including those having one or more USUBs.

In another aspect of the invention, a data structure is provided comprised of rows with applicability fields, each row being associated a parameter field, wherein, applicability fields are organized in a hierarchy defined by a user and include sets of characteristics in which at least one of the rows includes at least one unknown (i.e., yet present in the database, such as an aircraft type or airport identification), wherein further, such fields are populated with a universal substitute (USUB), thus enabling a query of the database which query accesses at least one field associated with a USUB to yield a meaningful, estimated result.

In another aspect of the invention, a retrieval method retrieves relevant data from the data structure in order to serve up useful information in response to a user's data query.

An object of the invention is to dramatically simplify data entry, so that rapid simulation can be performed on systems traditionally requiring large amounts of data.

In an advantage, the invention is easy for the ultimate user to appreciate as the interface is dramatically simplified.

In another advantage, the invention provides an easy process to input new knowledge of the business process just by adding further rows with less USUB parameter to the entries already made with stored rows. There is no need to delete previous rows of data where USUB was used.

In another advantage, the invention provides a very comprehensive decision making process in a reduced time period.

### BRIEF DESCRIPTION OF THE DRAWINGS

FIG. 1 is a flow chart of the initialization method of the invention.

FIG. 2 is a schematic diagram of the system of the invention.

FIG. 3 is a schematic diagram of the data structure of the invention.

FIG. 4 is a flow chart of the retrieval process of the invention.

### DETAILED DESCRIPTION OF THE PREFERRED EMBODIMENT

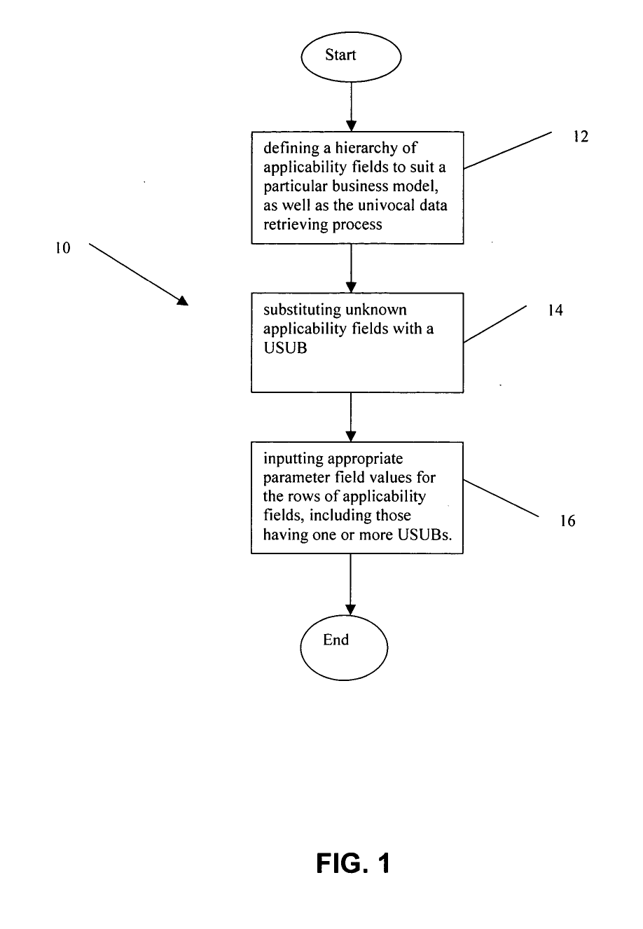

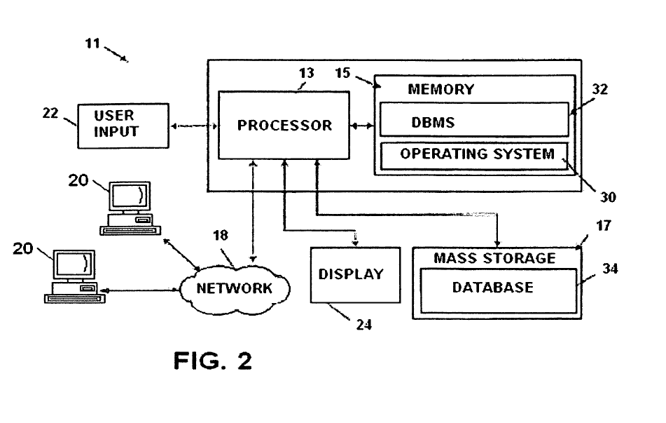

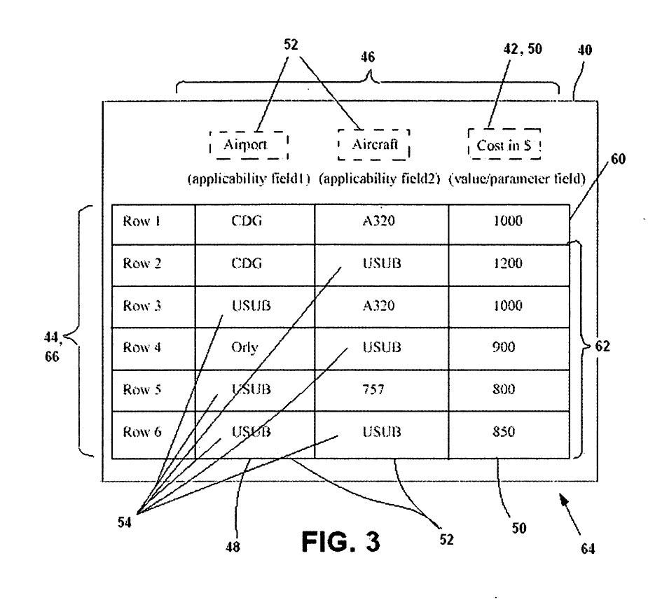

Referring now to FIG. 1, a computerized initialization method 10 is provided of populating a database table composed of rows with applicability fields and parameter fields (referred to in FIG. 3), such that the database may be used to yield relevant results with a minimum of data entries. The initialization method 10 includes three steps 12, 14, and 16. In the first step 12, the method 10 defines a hierarchy 62 (shown in FIG. 3) of applicability fields 52 to suit a particular business model as well as the univocal retrieval process 70. In a second step 14, the method substitutes unknown applicability fields with a USUB. In a third step 16, the method 10 prompts the input of appropriate parameter field values for the rows of applicability fields, including those having one or more USUBs. The initialization method 10 enables the population of a database 34 (shown in FIG. 2) such that the database may be used to yield relevant results with a minimum of data entries.

The database entry USUB 54 is a record entry that will substitute itself to any unspecified field value of the universe of possible values in database tables 40. Thus, a single database USUB record entry 54 could be assigned to table fields 48 to mean the field value could be any value of the “universe” of these fields. Multiple applicability fields could be associated with many USUBs 54 and will then produce a general value for all data combinations.

Referring now to FIG. 2, the methods 10, 70 are implemented in a hardware and software environment, on, for example, an apparatus 11. For the purposes of the invention, apparatus 11 may be any type of computer, or computer system, including a client computer, a server computer, a portable computer, or a handheld computer, etc. Moreover, apparatus 11 may be implemented using one or more networked computers, in a cluster or other distributed computing system such as the Internet. Apparatus 11 is hereinafter referred to as a “computer”.

Computer 11 typically includes at least one processor 13 coupled to memory 15. Processor 13 may represent one or more processors (e.g., microprocessors), and memory 15 may represent the random access memory (RAM) devices comprising the main storage of computer 11, as well as any supplemental levels of memory, e.g., cache memories, non-volatile or backup memories, read-only memories, etc. In addition, memory 15 may be considered to include memory storage physically located elsewhere in computer 11, e.g., any cache memory in a processor 13, as well as any storage capacity used as a virtual memory, e.g., as stored on a mass storage device 17 or on another computer coupled to computer 11 via network 18 (e.g., a client computer 20).

The computer 11 also typically receives a inputs and outputs for communicating information externally. For interface with a user or operator, the computer 11 typically includes multiple input devices 22 (e.g., a keyboard, a mouse, a trackball, a joystick, a touchpad, among others) and a display 24 (e.g., a CRT monitor, an LCD display panel, and/or a speaker, among others). Otherwise, user input may be received via another computer (e.g., a computer 20) interfaced with computer 11 over network 18, or via a dedicated workstation interface or the like.

For additional storage, the computer 11 may also include one or more mass storage devices 17, e.g., a floppy or other removable disk drive, a hard disk drive, a direct access storage device (DASD), an optical drive (e.g., a CD drive, a DVD drive, etc.), and/or a tape drive, among others. Furthermore, computer 11 may include an interface with one or more networks 18 (e.g., a LAN, a WAN, a wireless network, and/or the Internet, among others) to permit the communication of information with other computers coupled to the network. It should be appreciated that computer 11 typically includes suitable analog and/or digital interfaces between processor 13 and each of components 15, 17, 18, 22 and 24 as is well known in the art.

Computer 11 operates under the control of an operating system 30, and executes or otherwise relies upon various computer software applications, components, programs, objects, modules, data structures, etc. (e.g., database management system 32 and database 34, among others). Moreover, various applications, components, programs, objects, modules, etc. may also execute on one or more processors in another computer coupled to computer 11 via a network 18, e.g., in a distributed or client-server computing environment, whereby the processing required to implement the functions of a computer program may be allocated to multiple computers over a network.

Referring now to FIG. 3, a preferred embodiment of the invention manages parameter tables 40 stored in databases 34. Parameters 42 could be stored into rows 44 of database tables 40 composed of a set 46 of fields 48. Fields 48 of these rows 44 are of two kinds: parameter value fields 50, and applicability value fields 52. Each applicability field 52 could take a specific value among a set of values, which is referred to as the “universe” of the field. The use of USUB values 54 provide a simple implementation for (1) management of (temporarily) unknown applicability of mandatory parameters, and (2) management of data parameters that have a constant parameter value in the universe of this field.

Management of unknown parameters can be implemented by specification of a “default” or average value into the parameter fields 50 and by USUB values 54 in the applicability fields.

Management of data parameters that have limited specified values and constant values on the rest of the universe can be implemented by entering one row containing the general values into parameter fields 50 and “USUB” 54 into applicability fields 52. For each exception of this applicability, a new row has to be entered with the specific parameter value and the specific applicability.

Selection of Values into a Database with a USUB:

The selection process of table rows 44 containing USUB fields 54 is structured to select specified values 60 if a match is found with the applicability parameters, or to return rows 44 with USUBs 54 if no matches are found. In the case of multiple USUBs 54 in the same row 44 of data, the hierarchy 66 of the USUBs must be defined according to the needs of the associated business in order to guarantee that the data retrieval process will be univocal. The definition of the hierarchy between multiple USUB fields for the implementation of any data type will guarantee this condition.

The initialization method 10 of the invention modifies the conventional methodology of storing and retrieving data, as it is no longer a prerequisite to insert all values of applicable fields 48 to obtain a combination result from the database 34.

A definition of hierarchy between multiple USUB fields for the implementation of any data type can be created which must be in correlation with the business process the database is serving.

The need to populate a database with specified values to produce a result has been a requirement for many years, this invention displaces that requirement. Further with a minimum of entries a result can be obtained when previously a considerable amount of data entry was required.

Storing and Retrieving Parameters into a Table

For example, each parameter (cost values) 42 could be stored into a table row, which is set up by field value Fld[1] to Fld[n]. Some of these fields define the applicability of the parameter, some of these fields define the parameter value itself. The applicability fields may, for example, be associated with a USUB field J[1] to J[m], with m<n. A USUB field is defined by the name of the field and a value named “USUB value”.

Storing the Parameters Values

The USUB value 54 stored into a field 48 associated with a USUB field means that the parameter is unknown or the parameter is applicable for any value of the corresponding field.

Retrieving a Parameter

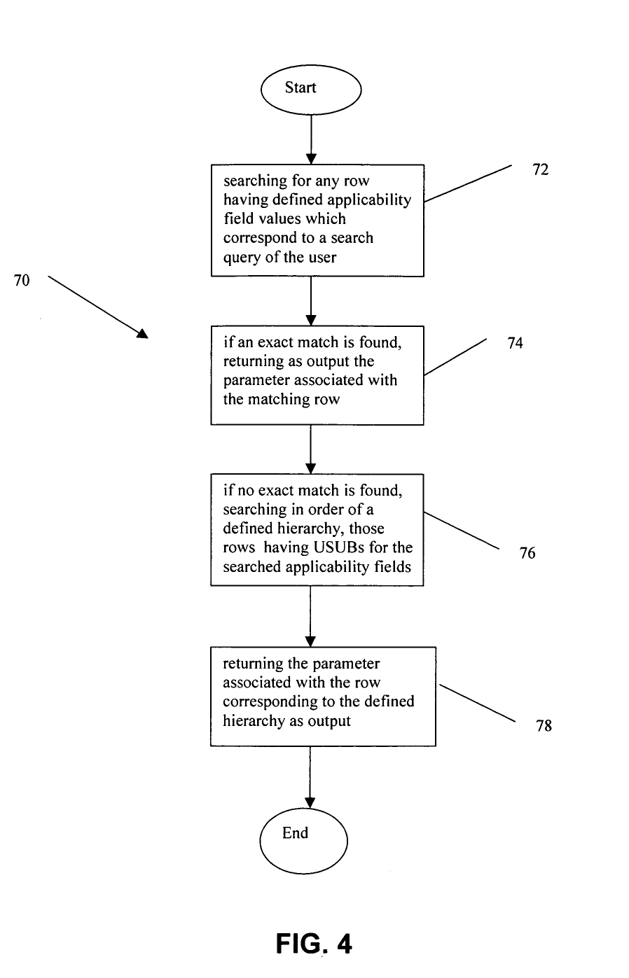

Referring now to FIG. 4, to retrieve a parameter, the developer must provide the corresponding searched value S[1] to S[m] for each parameter field 42. The retrieving process 70 is performed according to the following steps. In a first step 72, the process 70 searches for any row 44 having defined applicability field values which correspond to the search query. In a second step 74, if an exact match is found, the process 70 returns as output the parameter associated with the matching row. In a third step 76, if no exact match is found, the process 70 searches in order of a defined hierarchy 66, those rows 44 having USUBs 54 for the searched applicability fields. In a fourth step 78, the process 70 returns the parameter 42 associated with the row 44 corresponding to the defined hierarchy 66 as output.

In the first step 72, the retrieving process 70 looks for any row 44 that has the corresponding parameters:
Fld[i] is an exact match between the field value Fld[i] and the searched value S[i]
the field value S[i] contains the corresponding USUB value J[i]
where 1<=i<=m, and then the rows are stored in a temporary list.

In the third step 76, the retrieval process 70 sorts the rows 44 in the temporary list as described below, according to the applicable hierarchy 66, taking the USUB order as sort order. For each field 48, the USUB value 54 will be the lower sort criteria. In the fourth step 78, the retrieval process 70 retrieves the row 44 according the searched values (if any) at the top of the temporary list.

Thus, creating additional rows 44 with USUBs 54 substituted for every possible combination of unknown applicability field values 52 guarantees that one row will be retrieved for any combination of unknown applicability fields, even when no applicability field values are known.

Retrieving Process

The univocal data retrieving process is implemented as described below.

As select statement is sent to the database to retrieve the rows corresponding to the applicability fields. In a conventional data structure, to find the landing fee on an Airbus 320 Aircraft at Geneva airport, the select statement will be:

Select * from table_Landing_Fee
where f_airport_cde = ‘GVA’
and f_ac_type = ‘A320’

In case of no tariff defined for GVA and A320, the result of the request will be null. With the USUB invention, the select statement has to be modified as following:

Select * from table_Landing_Fee
where (f_airport_cde = ‘GVA’ or f_airport_cde =
USUB(f_airport_cde) )
and (f_ac_type = ‘A320’ or f_ac_type = USUB(f_ac_type) )

The result of the last query could be many rows:

| | f_airport_cde | f_ac_type | landing_fee |
|---|---|---|---|
| Row 1 | GVA | A320 | 512 |
| Row 2 | USUB(f_airport_cde) | A320 | 508 |
| Row 3 | GVA | USUB(f_ac_type) | 542 |
| Row 4 | USUB(f_airport_cde) | USUB(f_ac_type) | 600 |

If Row 1 is found, the corresponding parameter value stored into the field “landing fee” will be the expected result. If Row 1 is not stored into the database, the retrieval process has to select between Row 2 to Row 4. The retrieval process has to select the rows that have the “better match” between the applicability fields and the search values. In the above example, the result should be Row 2 or Row 3, because there is one match on applicability field on these rows. Row 4 has to be rejected because it has fewer matches.

In case of combination of multiple applicability fields with USUB, the number of matches cannot not give an univocal result. This is the reason why one must consider the hierarchy of the applicability fields. In the above case, the applicability field f_airport_cde, according to the business process, has a higher priority as field f ac type.

Finally if Row 1 is not found in the result of the select statement, the retrieval process should give Row 3 as the expected result.

To implement such a selection process, the rows 44 retrieved by the select statement using USUB values 54 have to be order according the applicability hierarchy. Each USUB value 54 of each parameter field 42 has to be considered as the lower value. In this case the sort of the above select statement will be as following

| | f_airport_cde | f_ac_type | landing_fee |
|---|---|---|---|
| Row 1 | GVA | A320 | 512 |
| Row 2 | GVA | USUB(f_ac_type) | 542 |
| Row 3 | USUB(f_airport_cde) | A320 | 508 |
| Row 4 | USUB(f_airport_cde) | USUB(f_ac_type) | 600 |

The retrieval process 70 has to select the row at the top of the list. If the row 44 with all match is found in the database 34, according to the sort process it will be at the top. If this row is not found, the Row 2 will be at the top and is the expected result.

Computer User Example

Referring again to FIG. 2, the invention is implemented in a system 11 including a computer 20, a database 34, input and output devices (not shown), with the methods 10, 70 being recorded on a computer-readable medium such that they are readable and executable by the system. In this example, data initialization is performed initially populating the database 34 with known and unknown data values for Airports and Aircraft.

Assuming that the hierarchy structure of the USUB which corresponds to the business process is that Airports have a higher status than an Aircraft, then the searches are performed as follows:
Search for CDG and an A320: Result from Row 1=1000
Search for CDG and a 747: Result from Row 2=1200
Search for CDG and a 757: Result from Row 2=1200
Search for Orly and an A320: Result from Row 4=900
Search for LYS and an A320: Result from Row 3=1000
Search for LYS and a 747: Result from Row 6=850.

Essentially, the system 11 searches, and when the applicability arguments of a query are not present in the universe of possible arguments, but one or more USUB symbols 54 are, then the system knows to replace the unknown with the USUB and return the parameter value 42 in the associated parameter value field.

Such requests are typically generated by a simulation based on a flight schedule or a query for a cost estimation of a nominal revenue-generating event, such as an aircraft, travelling from Orly airport to Heathrow airport, using a 737S. As has been shown, the use of a USUB 54, enables a user to get a first result for his simulation request with very few data entries. In an example analysis of an airline that has 130 routes a day, only one data entry is required to get a result, as is the case with the sample database below:

| | | | Cost in $ |
|---|---|---|---|
| | Airport | Aircraft | (value/parameter |
| | (applicability field1) | (applicability field2) | field) |
| Row 1 | USUB | USUB | 850 |

Here, with the single entry of a USUB value of $850, this value is returned. Similarly, if the Greek authorities have a single landing fee independent of the airport selected, the table would be as shown below:

| | | | Cost in $ |
|---|---|---|---|
| | Country | Airport | (value/parameter |
| | (applicability field1) | (applicability field2) | field) |
| Row 1 | Greece | USUB | 1000 |

Here again, in one line, using one input, the need to input the value “1000” for all Greek airports in avoided. Further, multiple dimensions of the USUB are possible, such as country, airport, aircraft, aircraft subtype, time of landing, etc. In another example, if one wishes to populate a database for an aircraft going to and from every airport in the world. In the traditional database, one must input a value for every airport in the world, in order to enable a query of the database not to return “null” as a result. Using the USUB, you can enter main airports where the user wishes to specify exact values, and then USUB everywhere else, inputting as a USUB value, the average cost of landing among the main airports, making the assumption that the table can be completed with this value.

The invention thus avoids the need to populate the entire database prior to generating results. The null value or familiar and meaningless “###” symbol result is avoided.

In another aspect of the invention, the reliability of the results may be indicated where an applicability field of the query is a USUB. Where one USUB is used, then, for example, a single asterisk can be displayed in a reliability indication output field. Where two USUBs are used, then two asterisks will be output along with the result, and so forth. This is a first level of reliability indication. A further level can reflect the reliability of the value input in the database in association with the USUB combination. For example, a reliability indication can reflect whether the associated value is an average or mean of the known values associated with the set, a value associated with a particular typical combination, and whether approved or unapproved (such as whether the value is a simple guess). If 90% of the result was obtained via application of USUBs, then 90% of the value is subject to question in order for the result to be verified as reliable. Of course, eventually, as the database is populated with actual values, the reliability of the output will be high.

In another aspect of the invention, a data structure 80 is provided comprised of rows 44 of applicability fields 52, each row being associated with a parameter field 42, wherein, applicability fields are organized in a hierarchy 66 defined by a user and include sets of characteristics in which at least one of the rows includes at least one unknown (i.e., yet present in the database, such as an aircraft type or new airport), wherein further, such fields are populated with a USUB 54, thus enabling a query of the database which query accesses at least one field associated with a USUB to yield a meaningful, estimated result.

In an advantage, results can be achieved with a minimum of database entries irrespective of the complexity of that database 34.

In another advantage, the use of the USUB values 54 provides a simple implementation for the management of (temporary) unknown applicability and values of mandatory parameters. A value for the USUB can be entered using a record.

In another advantage, the use of USUB values 54 provides a simple implementation for management of data parameters that have limited specified values and constant values on the rest of the universe.

In another advantage, management of unknown parameters can be implemented by specification of a “default”, mean, average, or other value into the parameters fields and by USUB values into the applicability fields.

In another advantage, the invention results in a simple, flat datastructure 64 without complicated application of subroutines to a complex data model in an effort to populate the database with plausible values.

Although particularly applicable to the transport field, the system 11 and associated methods 10, 70 could be applied to any database 34 where values are unspecified or where values are almost constant.

It should be noted that hierarchy tables defining hierarchy can be customized to particular industries, and thus, the data structure 64 can be organized to suit particular industries by the purveyors of the invention. Optionally, of course, initialization of the database 34 can be performed in which the user is prompted to input the preferred hierarchy among the applicability fields.

Multiple variations and modifications are possible in the embodiments of the invention described here. Although certain illustrative embodiments of the invention have been shown and described here, a wide range of modifications, changes, and substitutions is contemplated in the foregoing disclosure. In some instances, some features of the present invention may be employed without a corresponding use of the other features. Accordingly, it is appropriate that the foregoing description be construed broadly and understood as being given by way of illustration and example only, the spirit and scope of the invention being limited only by the appended claims.

1. A computer-readable medium encoded with a method of populating a database composed of rows, applicability fields and parameter fields, such that the database may be used to yield relevant results with a minimum of data entries, the method including the steps of:
a) defining a hierarchy of applicability fields to suit a particular business model, and the univocal retrieval process;
b) substituting unknown applicability fields with a USUB; and
c) inputting appropriate parameter field values for the rows of applicability fields, including those having one or more USUBs.

2. A data structure is provided comprised of rows with applicability fields, each row including a parameter field, wherein, applicability fields are organized in a hierarchy defined by a user and include sets of characteristics in which at least one of the rows includes at least one unknown, wherein further, such fields are populated with a universal substitute (USUB), thus enabling a query of the database which query accesses at least one field associated with a USUB to yield a meaningful, estimated result.

3. A retrieval method for retrieving data from the data structure of claim 2, includes the steps of:
a) searching for any row having defined applicability field values which correspond to a search query of the user;
b) if an exact match is found, returning as output the parameter associated with the matching row;
c) if no exact match is found, searching in order of a defined hierarchy, those rows having USUBs for the searched applicability fields; and
d) returning the parameter associated with the row corresponding to the defined hierarchy as output.
